(19) United States
(12) Patent Application Publication
(10) Pub. No.: US 2015/0258755 A1
(43) Pub. Date: Sep. 17, 2015

(54) MULTI-LAYER FILM

(71) Applicant: FIRST QUALITY PRINT & PACKAGING, LLC, Great Neck, NY (US)

(72) Inventor: Michael Kauschke, PRIEN (DE)

(21) Appl. No.: 14/656,423

(22) Filed: Mar. 12, 2015

Related U.S. Application Data
(60) Provisional application No. 61/952,699, filed on Mar. 13, 2014.

(51) Int. Cl. B32B 27/32; B32B 27/08; B29C 55/06; B29C 47/00; B29C 47/06; B29C 55/28; B32B 5/18; B32B 27/20

(52) U.S. Cl. CPC B32B 27/32; B32B 5/18; B32B 27/08; B32B 27/20; B29C 47/0057; B29C 47/065; B29C 55/28; B29C 55/06; B32B 2250/242; B32B 2307/54; B32B 2266/025; B29K 2023/0616

(57) ABSTRACT

A multi-layer film structure including two outermost film layers each comprising a polyethylene blend and an inorganic filler and at least three film layers disposed between the two outermost film layers, each of the at least three film layers comprising at least one of a polyethylene blend, a mono-component polyethylene and an inorganic filler.

### RELATED APPLICATION

This application is a non-provisional based on U.S. Provisional Patent Application No. 61/952,699, filed Mar. 13, 2014, the contents of which are incorporated herein by reference in their entirety.

### FIELD

The present disclosure relates generally to multi-layer films, and more particularly, but not limited to, multi-layer films used as a backsheet of an absorbent article.

### BACKGROUND

Conventional films used for hygienic and medical articles may be made of polymeric blends, colors and additives. These films may be manufactured as a mono-layer or as multi-layer, e.g. a double layer or a triple layer, either by using a blown film technology platform or, preferably, a cast film platform. The cast film process involves feeding the fresh extruded film into a gap, formed by a rubber roll and a micro-pattern engraved steel roll, where the speed between the molten polymer at the die exit and the roller gap is increased in order to obtain the desired film thickness. This down gauging draw step results in an un-desired increase in molecular orientation in the machine direction (MD), a decrease in molecular orientation in the cross direction (CD) and a relatively high “neck in” (measured and defined by the ratio between the width of the die gap vs. the final width) of the film. The MD molecular orientation increases the machine-oriented physical strength properties for high speed converting machines, but the lack of a high degree of uniformity (weight profile and its variation) across the film, together with the low level of CD strength properties, limits any further down gauging draw ratio and has an impact on the overall converting performance.

### SUMMARY OF THE INVENTION

An object of the present invention is to provide multilayer film compositions, and particularly, multi-layer films for use in hygienic and medical products.

Another object of the present invention is to provide multi-layer films having differing film structures defined by polymeric compositions and layer ratio.

Another object of the present invention is to provide a multi-layer film having a flexural resistance and extensibility gradient between single layers.

Another object of the present invention is to provide a multi-layer film having a flexural resistance and extensibility gradient from core to surface layers.

Another object of the present invention is to provide a multi-layer film having increased physical strength characteristics in the MD and CD directions, thereby providing an increased CD/MD strength ratio.

Another object of the present invention is to provide a multi-layer film having increased resistance to pin holes.

Another object of the present invention is to provide a multi-layer film having a non-glossy, soft touch surface.

Another object of the present invention is to provide a multi-layer film having a highly opaque, dense coloration.

Another object of the present invention is to provide a multi-layer film having high softness and drape.

Another object of the present invention is to provide a multi-layer film having increased uniformity, including low weight variation and caliper variation.

Another object of the present invention it to provide a multi-layer film that exhibits a low amount of noise.

A multi-layer film structure according to an exemplary embodiment of the present invention comprises: two outermost film layers each comprising a polyethylene blend and an inorganic filler; and at least three film layers disposed between the two outermost film layers, each of the at least three film layers comprising at least one of a polyethylene blend, a mono-component polyethylene and an inorganic filler.

A multi-layer film according to an exemplary embodiment of the present invention includes at least five layers.

In at least one embodiment, each layer of the multi-layer film has a different polymeric composition and degree of inorganic filler ratio.

In at least one embodiment, the multi-layer film is a breathable film in which each layer has a different ratio of filler to polymer matrix. For example, in a five layer structure, the core layer has a ratio of 30/70, the sub-skin layers have a ratio of 50/50, and the outer skin layers have a ratio of 70/30.

In at least one embodiment, the thickness or mass of each layer differs from core to skin.

In at least one embodiment, the flexural resistance gradient from core layers to skin layers decreases towards lesser or an ultra low flexural resistance.

In at least one embodiment, the outer skin layers are extensible, and have low strength and low shear resistance.

In at least one embodiment, one or more of the core layers includes one or more of the following types of materials: an inorganic filler (e.g., CaCO3), foam, elastic resin, highly extensible resin (blends of elastic and base polymer resins) and recycled resin.

In at least one embodiment, the multi-layer film has a density of 1.0 to 1.5 g/cm³.

In at least one embodiment, the multi-layer film has a thickness of less than about 2.5 mil, and preferably within a range of 0.4 to 0.7 mil.

In at least one embodiment, the multi-layer film is a component of a composite material, such as a nonwoven composite or printed composite.

A method of forming a multi-layer film structure according to an exemplary embodiment of the present invention comprises: extruding a multi-layer film precursor by a blown film method so as to form a multi-layer film, the multi-layer film precursor comprising: two outermost film layer precursors each comprising a polyethylene blend and an inorganic filler; and at least three film layer precursors disposed between the two outermost film layer precursors, each of the at least three film layer precursors comprising at least one of a polyethylene blend, a mono-component polyethylene and an inorganic filler; stretching the multi-layer film at least in the machine direction; and annealing the stretched multi-layer film.

Other features and advantages of embodiments of the invention will become readily apparent from the following detailed description, the accompanying drawings and the appended claims.

### BRIEF DESCRIPTION OF THE DRAWINGS

The features and advantages of exemplary embodiments of the present invention will be more fully understood with reference to the following, detailed description when taken in conjunction with the accompanying figures, wherein:

FIGS. 1A-1D are cross-sectional views of a multi-layer film according to exemplary embodiments of the present invention;

FIG. 2 is a cross-sectional view of a multi-layer film according to an exemplary embodiment of the present invention showing the shearing action of the film;

FIG. 3 is a diagram illustrating a system for making a multi-layer film according to an exemplary embodiment of the present invention; and

FIG. 4 is a scanning electron microscopy (SEM) image of a cross-section of a multi-layer film according to an exemplary embodiment of the present invention.

### DETAILED DESCRIPTION

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

The present invention is directed to a multi-layer film including outer polymeric layers including non-organic filler material and inner polymeric layers. The outer polymeric layers provide the film with a low noise, soft, drapable and non-glossy outer surface. The inner polymeric layers are preferably of a different polymeric formulation from that of the outer polymeric layers so as to address and provide a majority of the required strength properties of the film, including enhanced puncture resistance. The multi-layer film may also include at least one inner polymeric layer including non-organic filler material. The multi-layer film may have applications as, for example, a backsheet of an absorbent article and a structural component of medical drapes and gowns.

The multi-layer film of the present invention preferably has at least five layers, with adjacent layers having different polymer compositions and/or formulations. In an exemplary embodiment, up to three layers of the multi-layer film form the core of the film, and hence define the physical strength properties and characteristics of the film. In the case of a three-layer core, an inner core layer may be positioned between two outer core layers. The inner core layer may be softer, more drapable, have lower flexural resistance and be more extensible at low forces (weaker) as compared to the outer core layers. The two outer core layers may be considered “sub-skin” layers.

The multi layer film of the present invention provides a soft touch and non-glossy surface by making the skin, or outside, layers with highly filled formulations which change the characteristics of a “pure” polymeric film or layer towards lower flexural resistance, higher elongation, higher extensibility and lower strength. The sub-skin layers are formulated to take on the required strength properties of the film and are positioned as close as possible to the virtual centerline of the cross section cut. The inner core layer provides a soft, extensible layer which allows the two sub skin layers to shear independently when bending the film. The inner core layer may be a highly filled layer or a thin micro-cellular foam layer.

A similar objective is achieved by making the core layer as a high strength layer, with the sub skin and skin layers providing a gradient of increasing extensibility and softness and decreasing strength away from the core layer.

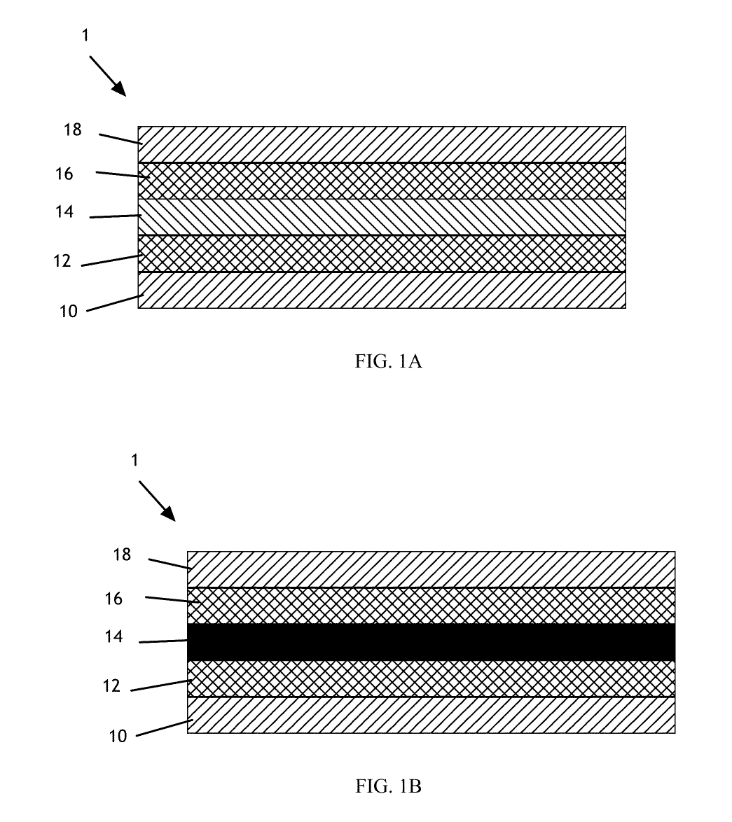

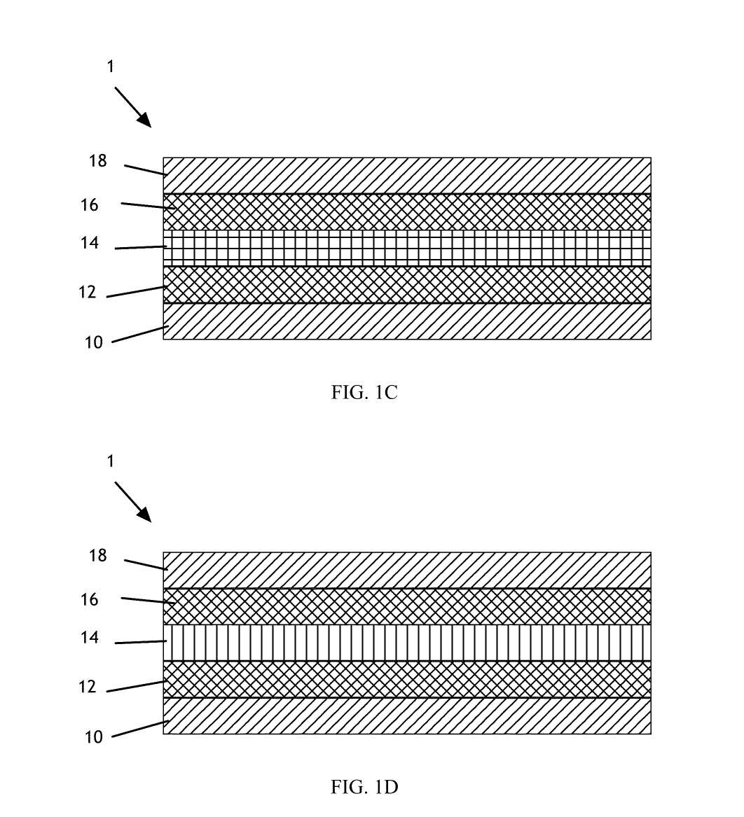

FIG. 1A is a cross-sectional view of a multi-layer film, generally designated by reference number 1, according to an exemplary embodiment of the present invention. The multi-layer film 1 includes two outer layers 10, 18 and three core layers, including two outer core layers 12, 16 and an inner core layer 14.

The two outer layers 10, 18 are made of a polyethylene blend with a high load of inorganic filler. The inorganic filler makes up 10 to 80% by weight of each of the two outer layers 10, 18. Inorganic filler materials include, for example, metal oxides, metal hydroxides, metal carbonates, metal sulfates, various kinds of clay, silica, alumina, powdered metals, glass microspheres, or void-containing particles. Specific examples of inorganic filler materials include calcium carbonate, barium sulfate, sodium carbonate, magnesium carbonate, magnesium sulfate, barium carbonate, kaolin, carbon, calcium oxide, magnesium oxide, aluminum hydroxide, and titanium dioxide. Inorganic filler materials also include, for example, those having higher aspect ratios than particles, such as talc, mica and wollastonite. The polyethylene blend in the two outer layers 10, 18 may be a blend of LLDPE, LDPE and/or MDPE. Each outer layer 10, 18 may have a thickness within a range of 1 and 5 microns. The outer layer formulations using LLDPE, LDPE and/or MDPE blends provide a low tear and shear resistant, extensible layer to minimize impact on soft drape-ability and bending resistance.

The outer, exposed surface of each outer layer 10, 18 preferably includes micro-fractures or micro-voids so as to provide the multi-layer film 1 in general with a soft, non-tacky, highly opaque surface. Without being bound by theory, the presence of the inorganic filler material facilitates the formation of the microvoids and the development of a porous structure in the film during stretching of the film. The micro-fractures and coarse particle agglomeration of the inorganic filler particles on the exposed surfaces of the outer layers 10, 18 provide a three-dimensional relief structure that improves mechanical “anchoring” of hot melt adhesives.

The two outer core layers 12, 16 are made of “non-filled” polymer or polymer blend. For example, the outer core layers 12, 16 may be made of polyethylene or a polyethylene blend. In the case of a polyethylene blend, the components of the blend may be LLDPE, LDPE and/or MDPE. Each outer core layer 12, 16 may have a thickness within the range of 1 and 7 microns.

The inner core layer 14 is made of a mono-component polymer, a polymer blend or a blend of a polymer and an inorganic filler (e.g., CaCO₃). The polymer and polymer blend for the inner core layer 14 may be polyethylene and a polyethylene blend, respectively. In the case of a polyethylene blend, the components of the blend may be LLDP, LDPE and/or MDPE. If the inner core layer 14 contains an inorganic filler, the inorganic filler may be present in the amount of 5% to 70% by weight of the inner core layer 14. The inner core layer 14 may have a thickness within the range of 3 to 15 microns.

As an alternative, the inner core layer 14 may be made of a homopolymer that is micro foamed. In general, the inner core layer 14 may be made of at least one of the following types of materials: soft polymeric film, a polymeric film having inorganic filler (FIG. 1A), recycled material (FIG. 1B), foam (open or closed cell structure) (FIG. 1C) and elastic material (e.g., Vistamaxx™, available from ExxonMobil Chemical Company of Irving, Tex., USA or INFUSE™ OBC available from The Dow Chemical Company of Midland, Mich., USA) (FIG. 1D).

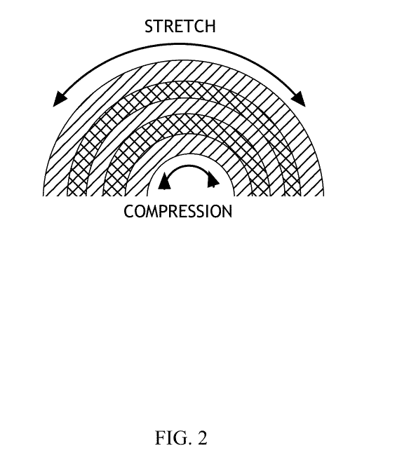

The multi-layer film according to an exemplary embodiment of the present invention has outer layers and an inner core layer that are less stiff, have less flexural resistance and exhibit more drape than outer core (i.e., “sub-skin”) layers that provide the strength characteristics of the multi-layer film. As shown in FIG. 2, the outer layers are able to stretch and compress to allow the stronger sub-skin layers to shear independently of one another, thereby providing the multi-layer film with improved drape.

In other exemplary embodiments, all layers of the multi-layer film are made of a polyethylene blend with a high load of inorganic filler (e.g., CaCO₃) in a range from 10 to 80% by weight. Each layer may have a different polymeric composition, where the differences are defined by the %-ratio of the single component resins and masterbatches in each layer, to obtain desired physical and optical properties of the overall film structure. This results in a film structure with five distinct layers of similar formulation, with the overall film structure being breathable due to the inorganic filler in each layer. In this exemplary embodiment, the thickness of the layers may have a ratio of, for example, 22.5/15/25/15/22.5(%).

In the case of a multilayer structure where all layers are of the same or similar composition (e.g. for breathable films), the structure by itself helps improve MD strength and pinhole resistance while maintaining the breathability. Multilayer structures made up of single layers, where each layer includes a different ratio between the filler and the matrix polymer(s), provide comparable results, e.g. 50, 60, 70% of filler blend with blends of polymers, or mono-component polymers and additives, balancing the 100% ratio.

In an exemplary embodiment of the present invention, the multi-layer structure is liquid impermeable and has a moisture vapor transmission rate (MVTR) below 500 g/24 hrs, preferably below 100 g/24 hrs.

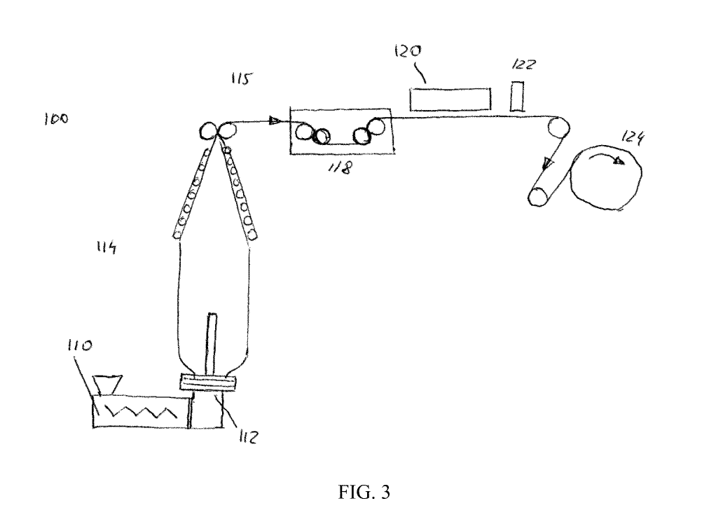

FIG. 3 is a diagram illustrating a system, generally designated as reference number 100, for making a multi-layer film according to an exemplary embodiment of the present invention.

The blown film extrusion begins with polymer melt being extruded with extruder 110 through an annular die 112. Temperature controlled air is injected through the center of the die 112, and the air pressure causes the extruded melt to expand into a film bubble 114. The air entering the bubble 114 replaces air leaving it, so that even and constant pressure is maintained to ensure uniform thickness of the film. According to an exemplary embodiment, the Blow-Up-Ratio (BUR) is within a range of 1:2.3 to 1:3.7. As used herein, the term “blow-up ratio” means the ratio of the die diameter to the maximum diameter of the blown tubular film.

Multiple film layers may be extruded through extruders 110, with each layer extruded through a separate extruder, to form a multi-layer film bubble, and ultimately the multi-layer film of the present invention. In this regard, each layer may be made of blends of mono- and co-polymers from the general family of polyolefines, such as, for example, compositions and formulations based on polyethylenes. In exemplary embodiments, such compositions and formulations of polytheylene include linear low-density polyethylene (LLDPE), low-density polyethylene (LDPE) medium-density polyethylene (MDPE) and metallocene polyethylene (mPE). The polymeric materials used to form each layer may include one or more masterbatches or compounds, such as, for example, color (e.g., TiO₂-white), processing aids, inorganic particle fillers (e.g., CaCO3, talcum, nano-clay, and micro-sized particle clays), slip agents, anti-block agents, antistatic agents and foaming agents.

The bubble 114 is pulled continually upwards from the die 112, and at the outside of the die exit, a cooling ring (not shown) blows air onto the film to solidify at least the film surface. The film may also be cooled from the inside using internal bubble cooling. This reduces the temperature to a point/range inside the bubble in order to obtain a solidified, cool film surface to avoid blocking or plastic cohesion when the tube is laid flat in the haul off nip, while maintaining the caliper of the film. After surface solidification, the bubble 114 is compressed by a set of nip rollers which collapse and lay flat the bubble 114 to form a film 115. After collapsing of the bubble 114, the film 115 is subjected to an MD-oriented stretching step at the stretching unit 118. The stretching unit 118 may include conventional MDO stretching equipment, such as an MDO unit available from Windmoller & Holscher KG, of Lengerich, Germany. In the stretching step, the film 115 is heated using heated rolls to a temperature of about 60° C. to 120° C. The film 115 is stretched in the machine-direction at a stretch ratio within a range of 50% to 500%, preferably within a range of 200% to 400%, and more preferably within a range of 300% to 400%. After stretching, the film 115 is subjected to an annealing step using heated rolls touching both surfaces of the film, where the temperature of the heated rolls are about 60 to 110° C. The annealing step allows for relaxation of stresses within the film 115.

After annealing, the film 115 is cooled down using, for example, steel rollers, to allow the film 115 to shrink in the machine direction up to 20%. The film 115 may be cooled down to a temperature of, for example, 50° C. or below. The stretching and annealing steps provide the film 115 with increased MD-oriented physical-mechanical properties and decreased caliper. In this regard, the caliper of the film 115 prior to stretching may be within the range of 20 to 60 microns, and after stretching and annealing the caliper may be within the range of 5 to 25 microns. The basis weight of the film 115 is preferably within the range of 10 to 20 gsm.

After the stretching and annealing steps, the film 115 is edge trimmed so as to form two multi-layer films.

After stretching, the film 115 may be subjected to corona treatment at corona treatment unit 120, slitting at slitting unit 122 and winding at winding unit 124.

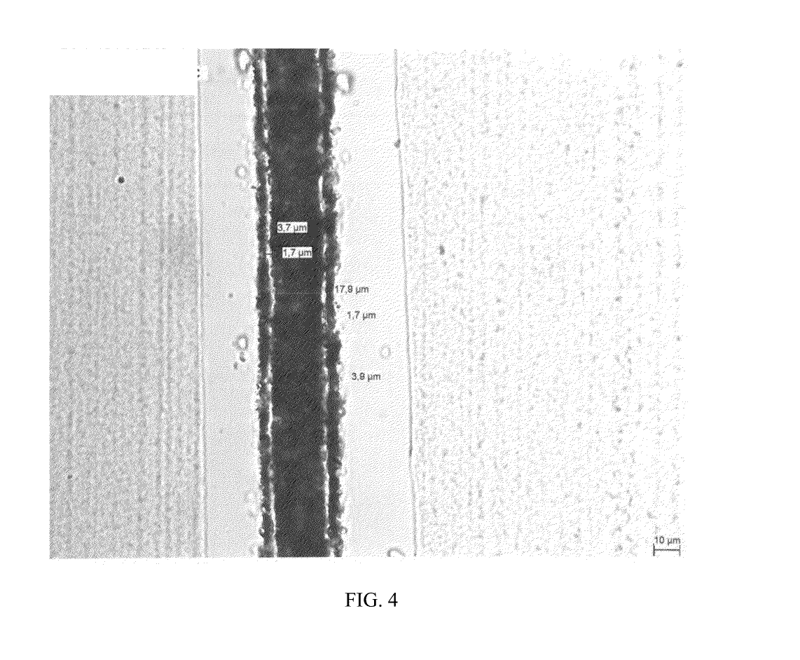

FIG. 4 is a SEM image of a multi-layer film according to an exemplary embodiment of the present invention prior to stretching and annealing. The two thin white layers are the liquid impermeable layers and the dark layers are the layers containing inorganic fillers at different ratio.

The following examples are provided to demonstrate the advantages of the present invention and are not intended to be limiting in any way.

### Example 1

A five layer film was provided having the following structure: A-B-A-B-A, where

A was a layer containing 70 wt % inorganic filler compound SCC 84695 (Standbridge Color Corporation, Georgia, USA) and 30 wt % Exceed™ 1012 HA mVLDPE (ExxonMobil Chemical Company, Houston, Tex., USA), and

B was a layer containing Exceed™ 1012 HA mVLDPE (ExxonMobil Chemical Company, Houston, Tex., USA).

The thickness ratio in the precursor formulation was 76% A and 24% B.

### Example 2

A five layer film was provided having the following structure: A-B-A-B-A, where

A was a layer containing 70 wt % inorganic filler compound SCC 84695 (Standbridge Color Corporation, Georgia, USA) and 30 wt % Exceed™ 1012 HA mVLDPE (ExxonMobil Chemical Company, Houston, Tex., USA), and

B was a layer containing Exceed™ 1012 HA mVLDPE (ExxonMobil Chemical Company, Houston, Tex., USA).

The thickness ratio in the precursor formulation was 48% A and 52% B.

### Example 3

A five layer film was provided having the following structure: A-B-B-B-A, where

A was a layer containing 70 wt % inorganic filler compound SCC 84695 (Standbridge Color Corporation, Social Circle, Georgia, USA) and 30 wt % Exceed™ 1012 HA mVLDPE (ExxonMobil Chemical Company, Houston, Tex., USA), and

B was a layer containing 100 wt % Exceed™ 1012 HA mVLDPE (ExxonMobil Chemical Company, Houston, Tex., USA).

The thickness ratio in the precursor formulation was 24% A and 76% B.

### Example 4

A five layer film was provided having the following structure: A-B-C-B-A, where

A was a layer containing 70 wt % inorganic filler compound SCC 84695 (Standbridge Color Corporation, Georgia, USA) and 30 wt % Exceed™ 1012 HA mVLDPE (ExxonMobil Chemical Company, Houston, Tex., USA), and

B was a layer containing 100 wt % Exceed™ 1012 HA mVLDPE (ExxonMobil Chemical Company, Houston, Tex., USA), and

C was a layer containing 100 wt % Lumicene™ Supertough 32ST05 (TOTAL Petrochemicals USA, Inc., Houston, Tex., USA).

The thickness ratio in the precursor formulation was 24% A, 48% B and 28% C.

### Comparative Example

A five layer film was provided having the following structure: A-C-D-C-A, where

A was a layer containing 70 wt % inorganic filler compound SCC 84695 (Standbridge Color Corporation, Georgia, USA) and 30 wt % Exceed™ 1012 HA mVLDPE (ExxonMobil Chemical Company, Houston, Tex., USA),

C was a layer containing 100 wt % Lumicene™ Supertough 32ST05 (TOTAL Petrochemicals USA, Inc., Houston, Tex., USA), and

D was a layer containing 100 wt % HDPE HTA 108 (ExxonMobil Chemical Company, Houston, Tex., USA).

For each Example, the basis weight, final gauge/thickness, opacity, 1% secant modulus, 2% secant modulus, 5% secant modulus, yield strength (psi), tensile strength (psi), force at break in MD (g), elongation at break (%), puncture resistance (g/mm) and handle-o-meter were measured. The secant modulus, yield strength, tensile strength, force at break and elongation at break were determined using the ASTM 882 test method. The puncture resistance was determined using the ASTM D-5748 test method. The opacity was determined using the ASTM D1003 test method. The results are shown in Table 1.

TABLE 1

| | EXAMPLE | EXAMPLE | EXAMPLE | EXAMPLE | COMPARATIVE |
|---|---|---|---|---|---|
| | 1 | 2 | 3 | 4 | EXAMPLE |
| Thickness-Ratio | A = 76%; | A = 48% | A = 24% | A = 24% | A = 24% |
| in precursor | B = 24% | B = 52% | B = 76% | B = 48% | C = 48% |
| formulation | | | | C = 28% | D = 28% |
| Basis weight | 14.5 gsm | 13.5 gsm | 14 gsm | 14 gsm | 11 gsm |
| Final gauge/ | 0.55 mil | 0.45 mil | 0.50 mil | 0.55 mil | 0.40 mil |
| thickness | | | | | |
| Opacity | 60% | 58% | 50% | 50% | 40% |
| 1% secant | MD 58.000 | MD 65.000 | MD 37.000 | MD 52.000 | MD 98.000 |
| Modulus, psi | CD 71.000 | CD 90.000 | CD 54.000 | CD 82.000 | CD 109.000 |
| 2% secant | MD 52.000 | MD 60.000 | MD 35.000 | MD 49.000 | MD 87.000 |
| Modulus, psi | CD 53.000 | CD 71.000 | CD 44.000 | CD 66.000 | CD 87.000 |
| 5% secant | MD 36.000 | MD 44.000 | MD 28.000 | MD 40.000 | MD 60.000 |
| Modulus, psi | CD 26.000 | CD 34.000 | CD 26.000 | CD 36.000 | CD 48.000 |
| Yield-strength, psi | MD 4.2 | MD 5.0 | MD 2.5 | MD 4.7 | MD 6.0 |
| | CD 1.6 | CD 2.2 | CD 1.5 | CD 2.2 | CD 3.0 |
| Tensile | MD 14.0 | MD 17.0 | MD 13.0 | MD 18.7 | MD 13.0 |
| strength, psi | CD 1.6 | CD 3.0 | CD 5.0 | CD 4.6 | CD 4.0 |
| Force at break, g, | 2652 | 3223 | 2950 | 3480 | 3120 |
| MD only | | | | | |
| Elongation at | MD 47 | MD 47 | MD 135 | MD 58 | MD 96 |
| break, % | CD 270 | CD 404 | CD 416 | CD 600 | CD 500 |
| Puncture | 8300 | 11700 | 11500 | 14400 | 14400 |
| resistance g/mm | | | | | |
| Handle-O-Meter | MD 1.80 | MD 1.85 | MD 1.18 | MD 1.33 | MD 2.32 |
| | CD 1.24 | CD 1.38 | CD 1.12 | CD 1.03 | CD 1.38 |
| | Overall | Overall | Overall | Overall | Overall |
| | Hand 1.52 | Hand 1.62 | Hand 1.15 | Hand 1.18 | Hand 1.85 |

In an embodiment, the five layer film forms a layer in a laminate. The laminate may contain additional film layers or nonwoven layers. In some embodiments, the laminate includes a nonwoven layer. The nonwoven layer may be made from continuous filaments, fibers or a combination of the both. In an embodiment, the nonwoven layer is a spunbond nonwoven. The nonwoven layer may also include additional spunbond layers or meltblown layers and may be a composite nonwoven such as an S-M-S (spunbond-meltblown-spunbond) laminate. In another embodiment, the nonwoven layer is made from staple fibers that have been bonded using one or more of thermal bonds, chemical bonds, ultrasonic bonds or hydroentanglement. One or more of the layers of the nonwoven may have fibers or filaments made from polypropylene, polyethylene, PET, viscose or PLA. The nonwoven layer may include natural fibers such as cotton, hemp, or wool, to name a few. The nonwoven layer may include bicomponent or multicomponent fibers or filaments. In an embodiment, the nonwoven layer includes spunbond filaments having a polyethylene sheath and polypropylene core. In some embodiments, the five layer film is bonded to the laminate via spray adhesive. The spray adhesive may be applied in lanes or may be applied in a random pattern. Without being bound by theory, it is believed that the microfractured surface of the film has improved adhesion of spray adhesive.

In an embodiment, the five layer film is used as the backsheet for an absorbent article such as diapers, training pants, protective underwear or feminine hygiene pads. In some embodiments, the backsheet includes a laminated outer nonwoven layer. In some embodiments, the five layer film of the backsheet is printed on the garment facing surface located between the film and the nonwoven. In some embodiments the garment facing surface of the nonwoven layer is printed or dyed. In an embodiment, a printed nonwoven layer includes unprinted regions that overlay printed regions on the film layer, where the opacity of the nonwoven layer is low enough to permit the graphic on the film layer to be seen. In some embodiments, the body facing surface is also printed with color fading or color changing inks to form a wetness indicator. Without being bound by theory, it is believed that the microfractured surface of the film has improved ink retention and allows for a reduced amount of ink to be used without a detrimental effect on image quality.

In embodiments, a backsheet made from the five layer film may include strained regions that provide increased breathability. Preferably, the strained regions have an MVTR that is at least twice as high as the unstrained regions. More preferably, the strained regions have an MVTR that is five times as high as the unstrained regions.

While particular embodiments of the invention have been illustrated and described, it would be obvious to those skilled in the art that various other changes and modifications may be made without departing from the spirit and scope of the invention. It is therefore intended to cover in the present disclosure all such changes and modifications that are within the scope of this invention.

1. A multi-layer film structure comprising:
two outermost film layers each comprising a polyethylene blend and an inorganic filler; and
at least three film layers disposed between the two outermost film layers, each of the at least three film layers comprising at least one of a polyethylene blend, a mono-component polyethylene and an inorganic filler.

2. The multi-layer film structure of claim 1, wherein the at least three film layers comprise:
at least two outer core film layers; and
a core film layer disposed between the at least two outer core film layers.

3. The multi-layer film structure of claim 2, wherein at least one of the at least two outer core film layers is devoid of inorganic filler.

4. The multi-layer film structure of claim 2, wherein the core film layer is devoid of inorganic filler.

5. The multi-layer film structure of claim 1, wherein the inorganic filler in each of the film layers containing inorganic filler is present in an amount within the range of 10% to 80% by weight.

6. The multi-layer film structure of claim 1, wherein the polyethylene blend and the mono-component polyethylene comprises at least one of LLDPE, LDPE and MDPE.

7. The multi-layer film structure of claim 1, wherein the film layers comprising inorganic filler are liquid and gas permeable.

8. The multi-layer film structure of claim 1, wherein film layers of the at least three film layers that are devoid of filler material are liquid impermeable.

9. The multi-layer film structure of claim 1, wherein the two outermost film layers comprise microvoids.

10. The multi-layer film structure of claim 9, wherein the microvoids are randomly dispersed throughout the two outermost film layers.

11. The multi-layer film structure of claim 9, wherein the microvoids have a size within the range of 1 to 50 microns.

12. The multi-layer film structure of claim 1, wherein the multi-layer film structure has a tensile strength in the machine direction of at least 10 psi.

13. The multi-layer film structure of claim 1, wherein the multi-layer film structure has a thickness of 2.5 mil or less.

14. The multi-layer film structure of claim 1, wherein the multi-layer film structure has a basis weight of 30 gsm or less.

15. The multi-layer film structure of claim 1, wherein the multi-layer film structure has a puncture resistance of at least 5000 g/mm.

16. The multi-layer film structure of claim 1, wherein the multi-layer film structure is formed by blown-film extrusion followed by stretching in the machine direction and annealing.

17. A method of forming a multi-layer film structure comprising:
extruding a multi-layer film precursor by a blown film method so as to form a multi-layer film, the multi-layer film precursor comprising:
two outermost film layer precursors each comprising a polyethylene blend and an inorganic filler; and
at least three film layer precursors disposed between the two outermost film layer precursors, each of the at least three film layer precursors comprising at least one of a polyethylene blend, a mono-component polyethylene and an inorganic filler;
stretching the multi-layer film at least in the machine direction; and
annealing the stretched multi-layer film.

18. The method of claim 17, wherein the multi-layer film precursor is extruded at a blow up ratio within the range of 1:2.7 and 1:3.7.

19. The method of claim 17, wherein the multi-layer film is stretched at a ratio within the range of 50% to 500%.

20. The method of claim 17, wherein the multi-layer film precursor is stretched at a ratio within the range of 300% to 400%.

21. The method of claim 17, wherein the multi-layer film precursor is annealed at a temperature within the range of 60° C. to 110° C.

22. The method of claim 17, wherein the at least three film layer precursors comprise:
at least two outer core film layer precursors; and
a core film layer precursor disposed between the at least two outer core film layer precursors.

23. The method of claim 22, wherein at least one of the at least two outer core film layer precursors is devoid of inorganic filler.

24. The method of claim 22, wherein the core film layer precursor is devoid of inorganic filler.

25. The method of claim 17, wherein the inorganic filler in each of the film layer precursors containing inorganic filler is present in an amount within the range of 10% to 80%.

26. The method of claim 17, wherein the polyethylene blend and the mono-component polyethylene comprises at least one of LLDPE, LDPE and MDPE.

27. The method of claim 17, further comprising the step of cooling the stretched and annealed multi-layer film to form the multi-layer film structure, the multi-layer film structure comprising:
two outermost film layers corresponding to the two outermost film layer precursors and each comprising a polyethylene blend and an inorganic filler; and
at least three film layers corresponding to the at least three film layer precursors and disposed between the two outermost film layers, each of the at least three film layers comprising at least one of a polyethylene blend, a mono-component polyethylene and an inorganic filler.

28. The method of claim 27, wherein the film layers comprising inorganic filler are liquid and gas permeable.

29. The method of claim 27, wherein film layers of the at least three film layers that are devoid of filler material are liquid impermeable.

30. The method of claim 27, wherein the two outermost film layers comprise microvoids.

31. The method of claim 30, wherein the microvoids are randomly dispersed throughout the two outermost film layers.

32. The method of claim 30, wherein the microvoids have a size within the range of 1 to 50 microns.
